(19) United States
(12) Patent Application Publication
(10) Pub. No.: US 2025/0091920 A1
(43) Pub. Date: Mar. 20, 2025

(54) System and Method for the Control of Mixed Liquor Fermentation

(71) Applicants: Nathaniel Stein, Sandy, UT (US); Sergio Pino-Jelcic, Salt Lake City, UT (US)

(72) Inventors: Nathaniel Stein, Sandy, UT (US); Sergio Pino-Jelcic, Salt Lake City, UT (US)

(73) Assignee: Ovivo Inc., Montreal (CA)

(21) Appl. No.: 18/433,032

(22) Filed: Feb. 5, 2024

Related U.S. Application Data
(60) Provisional application No. 63/539,233, filed on Sep. 19, 2023.

(51) Int. Cl. C02F 3/00; C02F 1/00; C02F 3/12; C02F 3/28; C02F 3/30; C02F 101/10; C02F 101/16

(52) U.S. Cl. CPC C02F 3/006; C02F 3/1221; C02F 3/28; C02F 3/301; C02F 2001/007; C02F 2101/105; C02F 2101/16; C02F 2201/005; C02F 2209/40; C02F 2301/043

(57) ABSTRACT

A system and method to control mixed liquor fermentation in a continuous-flow biological wastewater treatment process that removes organic matter, nitrogen and/or phosphorus provides for real-time adjustment of anaerobic solids retention time to initiate, optimize or cease mixed liquor fermentation in the anaerobic zone. Control is in response to signals from biological sensors monitoring microbial activity. Sufficient volatile fatty acids (VFAs) for the biological treatment process are generated endogenously, without bringing in sludge from primary sedementaiton or elsewhere. Efficiency of the process is increased, resulting in a smaller plant footprint requirement.

### BACKGROUND OF THE INVENTION

This application claims benefit of provisional application Ser. No. 63/539,233, filed Sep. 19, 2023.

Wastewater treatment plants (WWTPs) are driven to cost-effectively optimize their treatment process to produce treated water for discharge to the environment which meets environmental regulations established by governmental bodies. As the understanding of the nutrient loadings that receiving water bodies can sustain before suffering environmental degradation continues to improve, more stringent regulations have been introduced for the permissible nutrient levels in the treated effluent discharged from WWTPs. The introduction of these stringent regulations has presented a challenge to many WWTPs to reliably meet low nutrient limits in their treated effluent.

Nutrients enter into wastewater primarily through human waste, synthetic detergents, and various industrial processes. Excess discharge of these nutrients to receiving water bodies can lead to eutrophication, which accelerates the degradation in the aquatic ecosystem diversity and overall quality of the water body. The treatment of the nutrients present in wastewater is accomplished through biological nutrient removal (BNR). In BNR, various environments are provided to selectively grow bacteria which perform biochemical reactions that result in the removal of nutrients from the wastewater. Many of the bacteria involved with BNR require simple organic compounds, primarily in the form of volatile fatty acids (VFAs), to perform biochemical nutrient removal process and gain energy to grow. However, many WWTPs receive insufficient biodegradable organic material in their influent wastewater to generate the quantity of VFAs necessary to achieve the level of BNR required to meet stringent environmental regulations.

Fermentation is a process in which VFAs are generated from the anaerobic digestion of organic material and consists of two primary steps: hydrolysis and acetogenesis. Hydrolysis involves the conversion of biodegradable organic material to soluble organic acids, where acetogenesis then converts these soluble organic acids into VFAs. If the anaerobic digestion process is allowed to continue, methanogenesis will proceed and the VFAs generated will subsequently be converted to methane. Thus, the solids retention time (SRT) of a fermentation process is a parameter which must be optimized to provide enough time allowing for maximal hydrolysis and acetogenesis but ensures that the time provided is insufficient to allow for methanogenesis. Traditional fermentation processes have utilized the sludge generated from primary sedimentation clarifiers to produce VFAs for use in downstream BNR processes. However, many WWTPs do not incorporate primary sedimentation clarifiers in their treatment processes and subsequently do not have the option to ferment primary sludge to generate VFAs.

Return activated sludge (RAS) or mixed liquor suspended solids (MLSS) fermentation is an alternative to primary sludge fermentation which enables WWTPs that do not have primary sedimentation clarifiers to have the ability to produce VFAs for use in their BNR processes. RAS fermentation is typically performed by sending a small percentage (≤ 10%) of the RAS flow to a side-stream fermentation tank, where the RAS solids are retained in the tank for more than two days to allow for anaerobic digestion to proceed. MLSS fermentation is typically performed by contacting RAS with influent wastewater in an anaerobic tank to form mixed liquor, where a small percentage (≤10%) of the anaerobic mixed liquor is then sent to a side-stream fermentation tank to ferment. While RAS fermentation can generate sufficient VFAs, MLSS fermentation may be better suited for the support of BNR processes. This is because in MLSS fermentation, RAS is first contacted with influent wastewater, where soluble, particulate, and colloidal biodegradable carbon is adsorbed by the activated sludge flocs. MLSS fermentation allows for these adsorbed biodegradable carbon sources to also be fermented to form VFAs in addition to the VFAs generated from the anaerobic digestion of the RAS. This enables MLSS fermentation to yield more VFAs than RAS fermentation alone, while also enhancing the survival of bacteria involved with BNR as there is more fermentable substrate.

With currently available technologies for MLSS fermentation, it is difficult to reliably produce a consistent stream of VFAs to meet the needs of BNR processes. This stems from the inability of these technologies to directly monitor the microbial activity occurring in mixed liquor fermenters. As such, many WWTP operators find it challenging to optimize these technologies as there is limited to no direct feedback from the microbial activity due to operational changes. Furthermore, these technologies do not provide an unambiguous way to control the SRT of the fermenter other than through controlling the influent flowrate of mixed liquor (i.e. HRT=SRT). Consequently, the footprints of MLSS fermentation tanks are often sufficiently larger than would be necessary in a system where the SRT can be controlled.

What is needed, but not yet available, is a method of monitoring the real-time microbial activity within a mixed liquor fermenter to allow for the fermentation performance to be optimized to produce a fermentate with the desired quantity of VFAs to support the varying BNR needs of WWTPs.

### PRIOR ART

### US Pat. App. No. 2021/0214251 A1

Discloses a BES for monitoring the response of exo-electrogenic bacteria to one or more agents in oxygenated water or wastewater in a water treatment system.

Method for detecting and addressing system imbalances due to delivery of cleaning agents.

Key disadvantage—Application is for oxygenated environments. Intended for the optimization of aerobic wastewater treatment processes. Not suited for anaerobic fermentation environments.

### U.S. Pat. No. 11,352,272

Although the real-time metabolic activity in wastewater treatment processes can be monitored with this invention, the main application of this disclosure appears to be for optimizing membrane-based wastewater treatment processes through detecting and addressing system imbalances due to delivery of cleaning agents to a fouled membrane or up-stream treatment equipment.

### US Pat. App. No. 2020/0283314 A1

Discloses a BES for monitoring and controlling one or more organic carbon compounds in a wastewater treatment system.

Provides methods for controlling nitrogen and phosphorus removal processes in wastewater treatment processes through the controlled delivery of one or more organic carbon compounds.

Main disadvantage—Only monitors organic carbon compound levels in wastewater treatment processes to facilitate the controlled delivery of said organic carbon to facilitate nitrogen and phosphorus removal. Disclosure does not describe how the BES can be implemented to control fermentation for the production of organic carbon compounds (i.e. VFAs).

### U.S. Pat. No. 11,150,213

Only discloses a system and method for monitoring BOD using a BES. Does not detail how the BOD reading can be utilized for wastewater treatment process optimization.

### U.S. Pat. No. 6,387,264

Discloses the Unified Fermentation and Thickening (UFAT) process.

Requires WWTPs to have primary clarifiers to produce a stream of primary sludge to ferment to generate VFAs for use in BNR processes.

Many WWTPs do not have primary clarifiers in their process and thus this process is limited in its application.

### U.S. Pat. No. 7,285,215

Side-stream mixed liquor fermentation reactor operated at a long HRT (2-days) and without mixing to ensure an SRT is reached to allow for acetogenesis to occur. This is not ideal as it requires a large reactor footprint and/or low flowrates.

No mixing in side-stream mixed liquor fermentation reactor makes it difficult to control the SRT of the reactor. If solids stay too long in the system, then methanogenesis will occur and consume the generated VFAs, thus decreasing the VFA production efficiency.

### US Pat. App. No. 2021/0047218 A1

Utilizes a dissolved air flotation (DAF) unit to separate solids from the influent wastewater and directs the floated solids to a side-stream fermenter. It is not ideal to have a DAF positioned on the main-stream treatment line as DAF units have limited capacity, are sensitive to temperature changes, can be complex and require skilled operators, and DAF units require the use of chemical coagulants or flocculants which can be operationally expensive.

### US Pat. App. No. 2020/0172850

Utilizes solid electrodes to provide reducing equivalents to yield tunable fermentation products within a microbial fuel cell (MFC) reactor configuration.

The downside to this invention is that solids electrodes are required to drive the fermentation process, which may be both expensive and complex to operate for full-scale implementations at WWTPs.

MFCs also have limited capacity and likely would not be suitable for mixed liquor fermentation applications.

### SUMMARY OF THE INVENTION

This invention disclosure provides a system and method for controlling the fermentation of MLSS to optimize the endogenous production of VFAs for the BNR needs of WWTPs. The system provides an anaerobic mixed liquor fermentation tank (AnMLFT) which receives the controlled delivery of RAS and screened and de-gritted wastewater (SD-WW). The AnMLFT is equipped with a mixing device whose mixing intensity can be adjusted in a controlled manner with a variable frequency drive (VFD), motor, and/or solenoid valve. The system also incorporates a biosensor suspended in the AnMLFT basin to monitor the real-time soluble biodegradable carbon utilization rate (SBCUR). A control unit is incorporated into the system to allow for adjustments to be made to the operation of the AnMLFT at least partially in response to the real-time SBCUR data recorded by the biosensor. These operational adjustments may be initiated by the control unit when real-time SBCUR readings from the biosensor deviate beyond thresholds set to optimize the fermentation of MLSS. The system allows for automated adjustments to be made to the rate of flow of RAS and SD-WW to the AnMLFT in response to real-time SBCUR readings. The system also allows for automated adjustments to be made to the output from the mixing device(s) in the AnMLFT in response to the real-time readings from the biosensor. These operational adjustments allow for the hydraulic retention time (HRT), SRT, and influent RAS-to-SD-WW flow ratio to be modulated in real-time to optimize the fermentation of MLSS in the AnMLFT to yield a fermentate consisting of VFAs within a desired concentration range.

This invention may be embodied in either in-line or side-stream configurations within BNR processes. For in-line embodiments, MLSS fermentation is performed in cycles which coincide with the diurnal loading patterns of WWTPs. Under normal flow conditions, the AnMLFT operates as a typical anaerobic selector tank of an Anaerobic/Anoxic/Oxic (A20) BNR process, where 100% of the RAS and SD-WW are delivered to the tank for a specified HRT. Under low flow conditions (i.e. early morning, 2-4 AM), the soluble biodegradable carbon (SBC) loading to the AnMLFT will be significantly lower than under normal flow conditions, which will be detected by the biosensor through a sharp decrease in SBCUR readings. When this occurs, the control unit will initiate the system to proceed into fermentation mode. In fermentation mode, 100% of the RAS will proceed to the AnMLFT while the rate of flow of SD-WW may be modulated to target a specified HRT and/or RAS to SD-WW flow ratio which optimizes MLSS fermentation. The initiation of the system into fermentation mode will also include diverting the mixed liquor recycle (MLR) discharge location within the pre-anoxic basin of a BNR process to be diverted further downstream in the pre-anoxic basin such that a larger anaerobic volume can be developed. Fermentation mode will also signal to the mixing device(s) in the developed anaerobic volumes of a BNR process to adjust their output to provide a mixing intensity which allows for solids to accumulate such that an SRT which optimizes MLSS fermentation can be provided in the anaerobic volumes. When the influent to a WWTP begins to return to normal flow conditions in response to diurnal loading patterns, the SBC loading to the AnMLFT will be significantly higher than under low flow conditions, which the biosensor will detect through a sharp increase in SBCUR readings. When this occurs, the control unit will cease fermentation mode and return the system back to normal A2O operation. This embodiment allows WWTPs to perform MLSS fermentation within an existing plant footprint without making major infrastructure changes or sacrifice to effluent quality. Additionally, this embodiment enables WWTPs to harvest endogenous sources of VFAs to supplement their BNR processes to allow for enhanced process reliability, robustness, and intensification.

In side-stream embodiments of this invention, the AnMLFT is positioned off the main treatment path of a BNR process. The AnMLFT is equipped with a biosensor such that the real-time SBCUR in the tank can be monitored and utilized to optimize MLSS fermentation. Conduit equipped with flow control devices enables the controlled delivery of RAS and SD-WW from the main-stream BNR process to be made to the side-stream AnMLFT in response to real-time SBCUR readings from the biosensor. Mixing device(s) installed in the AnMLFT can modulate their output through VFDs, variable speed motors, or through solenoid valves to deliver a mixing output which enables solids to accumulate in the system such that an SRT which maximizes acetogenesis can be achieved through real-time SBCUR readings from the biosensor. Conversely, under completely mixed conditions when the HRT of the AnMLFT is equivalent to its SRT, the influent flowrate may be modulated such that the HRT of the AnMLFT is equivalent to the SRT which maximizes acetogenesis, determined through SBCUR readings from the biosensor. VFA-rich effluent from the AnMLFT is then conveyed to the anaerobic selectors of the mainstream BNR process. This side-stream embodiment of this invention enables real-time optimization of side-stream mixed liquor fermentation processes to consistently yield a VFA-rich effluent to support the BNR needs of WWTPs. Although additional infrastructure is required for this embodiment, the benefit lies with the continuous delivery of VFAs to a BNR process rather than intermittently as detailed in the previous embodiment.

The system and method provided in this disclosure enable MLSS fermentation to be continuously optimized through monitoring the real-time SBCUR within an AnMLFT using a biosensor. Real-time SBCUR readings enable operational changes to be made to an AnMLFT to maximize the production of VFAs through acetogenesis. These operational changes can include adjusting the reactor HRT, SRT, output delivered from mixing devices, and the flow ratio of RAS to SD-WW in the influent. Multiple biosensors may be incorporated into a mixed liquor fermentation system at the inlet, outlet, and/or throughout the system to provide better process control to maximize VFA production. Through optimizing the hydrolytic fermentation activity in MLSS fermentation reactors with this invention, WWTPs can achieve more robust and reliable BNR performance with less dependence on influent SBC loadings and exogenous chemical addition. Overall, this invention allows WWTPs to intensify their process through improving their carbon management efficiency to reliably meet stringent environmental regulations.

### DESCRIPTION OF THE DRAWINGS

FIG. 1 shows an example of an AnMLFT equipped with a biosensor for the controlled delivery of RAS and SD-WW.

FIG. 2 shows a schematic of an AnMLFT equipped with submersible mixers and a biosensor, allowing for the controlled delivery with RAS and SD-WW along with control of mixing intensity via submersible mixers.

FIG. 3 shows a schematic of an AnMLFT equipped with a submerged turbine mixer and a biosensor, allowing for controlled delivery of RAS and SD-WW along with control of mixing intensity provided by the submerged turbine mixer.

FIG. 4 is another schematic of an AnMLFT, equipped with compressed gas mixing and a biosensor, allowing for controlled delivery of RAS and SD-WW along with control of mixing intensity.

FIG. 5 is a process flow schematic showing a preferred in-line embodiment of the invention.

FIG. 6 is a process flow schematic for the preferred side-stream embodiment of the invention.

FIG. 7 is a flow chart depicting operation of a control unit for the optimization of each operational control parameter for the AnMLFT individually in response to real-time SBCUR reading from the biosensor.

FIG. 8 is a flow chart showing operation of the control unit for adjusting each of the operational control parameters of the AnMLFT simultaneously in response to real-time biosensor SBCUR readings and current operating states of each operational control parameter.

FIG. 9 shows a hypothetical example of a control process developed for an in-line embodiment of the invention wherein MLSS fermentation is initiated cyclically in response to SD-WW flow meter readings, SD-WW biosensor SBCUR readings, and ouput supplied by the mixing device.

FIG. 10 shows another hypothetical example of a control process developed for a side-stream embodiment of the invention, where MLSS fermentation is continuously optimized in response to the biosensor SBCUR readings, the output from the mixing device, and the approximated SRT of the AnMLFT.

### DESCRIPTION OF PREFERRED EMBODIMENTS

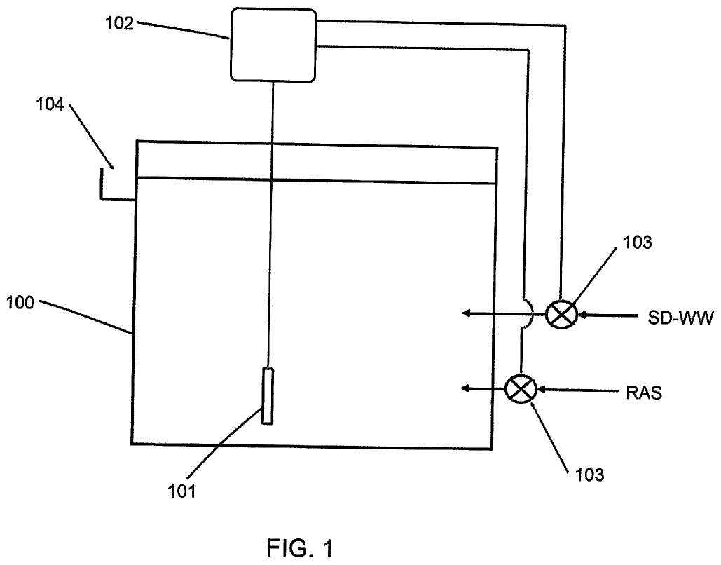

FIG. 1 provides a basic schematic of a mixed liquor fermentation system which incorporates a biosensor for control. The system provides an AnMLFT 100 equipped with a biosensor 101 to monitor the real-time SBCURs in the tank and communicate the readings to a control unit 102. When the SBCUR readings from the biosensor 101 deviate beyond thresholds set to optimize MLSS fermentation, the control panel 102 sends a signal to a flow control device 103 to adjust the delivery of RAS and/or the delivery of SD-WW to the AnMLFT 100. The effluent of the fermenter containing VFAs flows over a weir into a collection trough 104 which can be conveyed to the unaerated zones of BNR processes to enhance their performance. This method may be utilized to optimize the HRT of the AnMLFT and the RAS-to-SD-WW flow ratio in the influent to maximize the production of VFAs through acetogenesis.

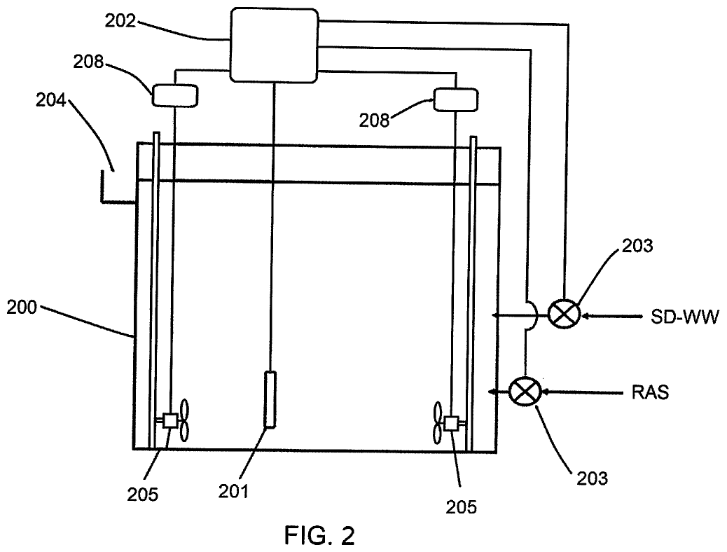

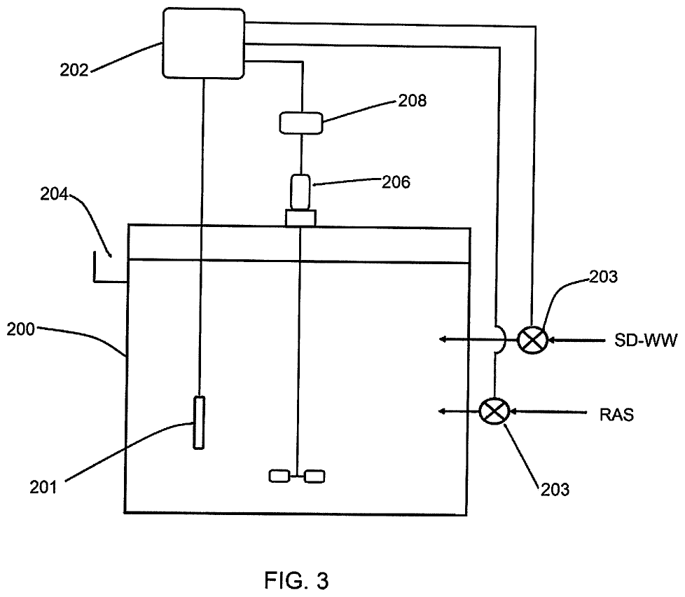

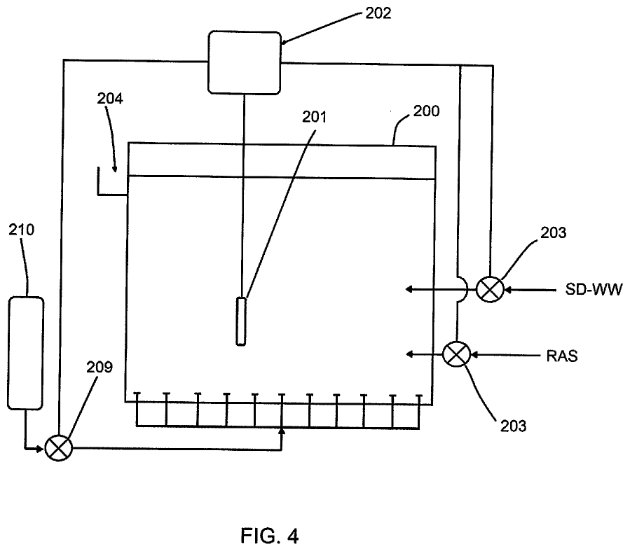

The biosensor may also be utilized to optimize the mixing intensity within a fermentation reactor, as depicted in FIGS. 2-4. For these examples, the mixing device can either be a submersible mixer 205, a submerged turbine mixer 206, a compressed gas mixer 207, or a combination thereof (not illustrated). For submersible mixers 205 and submerged turbine mixers 206, the control unit 202 will send a signal to a variable frequency drive 208 to control the voltage supplied to the motor of the mixing device in response to the signal from the biosensor 201. For compressed gas mixing, the control unit 202 communicates with a gas flow control device 209 to control the flow of a gas from a compressed gas storage tank 210 to the AnMLFT 200 in response to the signal form the biosensor 201. Regardless of which mixing device is utilized, control of the AnMFLT 200 will proceed according to the same methodology. A biosensor 201 suspended in an AnMLFT 200 monitors the real-time SBCUR and communicates the data to a control unit 202. If the SBCUR readings from the biosensor 201 deviate beyond threshold limits set to optimize MLSS fermentation, the control unit 202 will send a signal to the mixing device to cease, initiate, increase, or decrease the output from the mixing device(s) in the AnMLFT 200. This method may also be utilized for SRT control through on/off cycling the mixing device to allow for solids to accumulate in the AnMLFT 200, thus allowing for the SRT of the system to exceed the HRT. The SBCUR reading from the biosensor 201 allows for the time a mixer is on and the time the mixing device is off to be optimized such that the SRT of the AnMLFT 200 approaches the SRT which maximizes acetogenic activity and consequently optimizes the production of VFAs from MLSS fermentation to support the BNR needs of a WWTP.

### Advantages

The invention disclosed herein provides multiple advantages over prior art. The primary advantage of the invention is that the real-time SBCUR within a mixed liquor fermentation reactor can be directly monitored such that the process can be optimized to yield the desired production of VFAs required for the BNR needs of a WWTP. Previous inventions incorporating mixed liquor fermenters for VFA production (see U.S. Pat. No. 7,285,215) are operated with low influent flowrates to yield reactor HRTs that are equivalent to the SRT needed for acetogenesis. While these previous inventions enable the production of VFAs from mixed liquor to support BNR, they are difficult to optimize with changing influent characteristics as there is no direct feedback from the microbial activity within the system. Furthermore, designing mixed liquor fermenters with an HRT equivalent to the SRT needed for acetogenesis (≥2 days) results in large reactor footprints (increased capital costs) and/or low flowrates.

This invention enables WWTPs which do not have primary sedimentation clarifiers, and subsequently access to primary sludge, incorporated into their treatment processes to have the ability to endogenously produce VFAs for use in their BNR processes in an optimized manner from mixed liquor fermentation. This allows for BNR processes to be more efficient, reliable, robust, and can move BNR process performance towards becoming independent from variable influent nutrient loadings.

Another advantage of the invention provided in this disclosure is that it can be retrofitted into existing in-line or side-stream mixed liquor fermentation reactors to optimize their performance without making major changes to the existing infrastructure.

### New Features

A biosensor incorporated into an anaerobic mixed liquor fermentation reactor allows for the real time monitoring of the SBCUR within AnMLFTs, which can enable real time process optimization to yield the desired production of VFAs required for the BNR needs of a WWTP. Real-time microbial activity monitored through SBCUR readings using a biosensor allow for real-time process optimization of MLSS fermenters through modulating the reactor HRT, SRT, and the RAS-to-SD-WW flow ratio in the influent.

### Alternate Embodiments

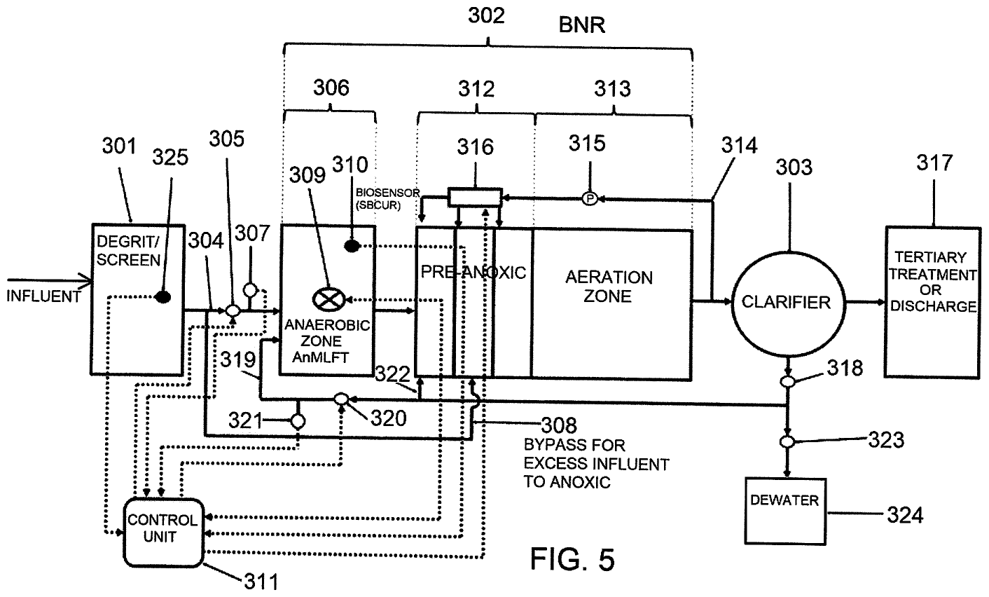

The method of MLSS fermentation control provided through this invention can be embodied as an in-line configuration within a wastewater treatment process, as depicted in FIG. 5. The wastewater treatment process consists of at least an upstream mechanical screening and de-gritting process 301, a BNR process 302 with two or more process zones, and a downstream gravity settling clarifier 303. Within this embodiment, wastewater following a screening and de-gritting process 301 flows through conduit 304 equipped with a flow control device 305 to the AnMLFT 306. A flow meter 307 is also equipped on the influent conduit 304 to detect the rate of SD-WW flow to the AnMLFT 306 and communicate the readings to a control unit 311. Excess SD-WW not needed in the AnMLFT 306, may be diverted through a bypass conduit 308 to one or more of the process zones of a downstream BNR process 302. The AnMLFT 306 is equipped with a mixing device 309 and a biosensor 310 which monitors the real-time SBCUR within the tank and communicates the readings to a control unit 311. Overflow from the AnMLFT 306 proceeds to a downstream pre-anoxic basin 312 consisting of multiple tanks in series and whose effluent flows to a downstream aeration basin 313. A portion of the aeration basin 313 effluent is recycled back to the pre-anoxic basin 312 through conduit 314 equipped with an MLR pump 315. An automated flow diversion device 316 incorporated in the MLR conduit 314 allows for the MLR to be diverted to any of the tanks composing the pre-anoxic basin 312. Effluent from the BNR process 302 proceeds to a gravity settling clarifier 303, whose overflow is sent for tertiary treatment and/or discharge 317. Underflow from the gravity-settling clarifier 303 is pumped with a RAS pump 318 through conduit 319 equipped with a RAS flow control device 320 to the AnMLFT 306. A flow meter 321 is equipped on the RAS conduit 319 downstream of the RAS flow control device 320 to detect the RAS flow to the AnMLFT 306 and communicate the readings to the control unit 311. Excess RAS not needed in the AnMLFT 306 may be diverted through bypass conduit 322 to the downstream pre-anoxic basin 312. RAS needing to be wasted from the BNR process 302 is pumped from the clarifier underflow with a WAS pump 323 to a thickening and/or dewatering process 324. An additional biosensor 325 may be incorporated into the screening and de-gritting process 301 such that it is suspended in a channel which conveys SD-WW to the influent conduit 304 for the BNR process 302. As such, the additional biosensor 325 may be utilized to monitor the SBC concentrations in the SD-WW and convey the readings to the control unit 311.

The in-line configuration of this invention may be best embodied through having effluent from the AnMLFT 306 flow into a modified Ludzack-Ettinger (MLE) process. Preferably, the pre-anoxic basin of MLE process would consist of two or more anoxic tanks in series where the MLR discharge location can be varied between the individual anoxic tanks with a flow diversion device 316, as depicted in FIG. 5. Through having the flexibility to move the MLR discharge further downstream in a pre-anoxic basin, the subsequent anaerobic volume of the BNR process 302 can be increased. This embodiment may be best implemented cyclically to mimic the diurnal flow patterns of a WWTP. Under normal operating conditions, the AnMLFT 306 may function as the typical anaerobic selector of an Anaerobic/Anoxic/Oxic (A2O) BNR process, where 100% of the influent SD-WW and RAS are delivered to the AnMLFT 306 for a specified HRT. Under low flow conditions, the SBC loading to the AnMLFT 306 will be much lower compared to normal flow conditions, which will be detected through a sharp decrease in SBCUR readings from the SD-WW biosensor 325. When this occurs, the control unit 311 will initiate the AnMLFT 306 to proceed into fermentation mode. Under fermentation mode, 100% of the RAS will be directed to the AnMLFT 306 while the SD-WW flow may be modulated to meet an optimum reactor HRT and/or RAS-to-SD-WW flow ratio, both of which can be optimized through the real-time readings from the biosensor 310. With the initiation of fermentation mode, the control unit 311 will also communicate to the automated flow diversion device 316 to divert the MLR to anoxic tanks farther downstream in the pre-anoxic basin 312 to allow for a larger anaerobic volume to be developed, effectively increasing the HRT of the AnMLFT 306. The initiation of fermentation mode will also include the control unit 311 directing the mixing device(s) 309 in both the AnMLFT 306 and the tanks in the pre-anoxic basin 312 which are not receiving MLR to proceed into fermentation mode mixing. In fermentation mode mixing, the mixing device(s) 309 will be directed to supply an output which applies a mixing intensity that allows solids to accumulate in the anaerobic volume to a point where the anaerobic SRT approaches the SRT which maximizes acetogenesis and subsequently the production of VFAs, which can be detected through SBCUR readings using the biosensor 310. When the influent begins to return to normal flow conditions, the SBC loading to the AnMLFT 306 will be much higher than under low flow conditions, which would be detected through a sharp increase in SBCUR readings from the biosensor 325. When this occurs, the control unit 311 will terminate fermentation mode and initiate the system to proceed back into normal A2O operation.

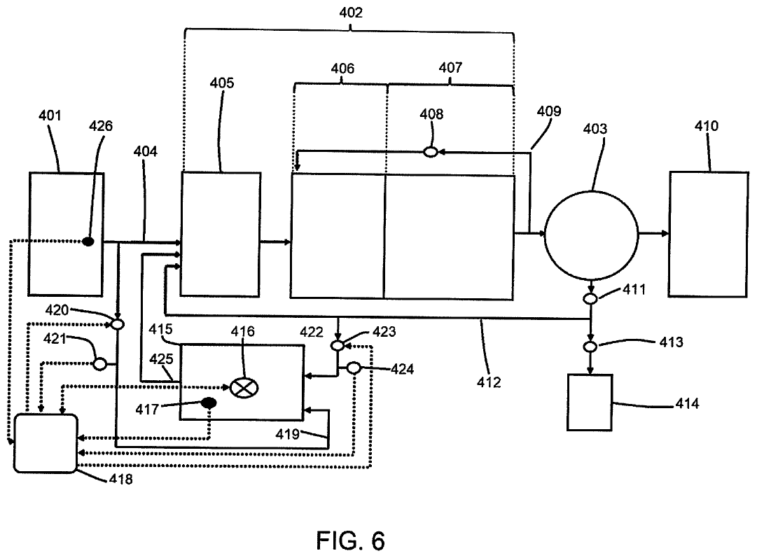

In an alternative embodiment, the method of MLSS fermentation control detailed in this disclosure can be applied in a side-stream configuration within a continuous flow biological wastewater treatment process, as depicted in FIG. 6. The wastewater treatment system consists of at least an upstream mechanical screening and de-gritting process 401, a BNR process 402 with two or more process zones, and a downstream gravity settling clarifier 403. In this embodiment, wastewater following a screening and de-gritting process 401 flows through conduit 404 to the anaerobic tank 405 of an A2O BNR process 402. The anaerobic tank 405 overflows into a pre-anoxic basin 406 which then feeds into a downstream aeration basin 407. A portion of the aeration basin 407 effluent is pumped with an MLR pump 408 through conduit 409 to the upstream end of the pre-anoxic basin 406. Effluent from the BNR process 402 proceeds to a gravity settling clarifier 403 in which the overflow proceeds to a tertiary treatment process and/or discharge 410. Underflow from the gravity-settling clarifier 403 is pumped with a RAS pump 411 to the anaerobic selector 405 of the A2O BNR process 402 through conduit piping 412. Biomass needing to be wasted from the BNR process 402 is pumped from the clarifier underflow with a WAS pump 413 to a thickening and/or dewatering process 414. The AnMLFT 415 is positioned on the side-stream of the A2O BNR process and is equipped with a mixing device 416 and a biosensor 417 which monitors the real-time SBCUR within the tank and communicates the readings to a control unit 418. SD-WW is diverted to the AnMLFT 415 through conduit 419 equipped with a flow control device 420 branching off the main conduit 404 delivering SD-WW to the A2O BNR process 402. A flow meter 421 is also incorporated into the SD-WW conveyance conduit 419 downstream of the flow control device 420 to detect the SD-WW flow to the AnMLFT 415 and communicate the readings to the control unit 418. RAS is diverted to the AnMLFT 415 through conduit 422 equipped with a flow control device 423 branching off the main conduit 412 delivering RAS to the A2O BNR process 402. A flow meter 424 is also incorporated into the RAS conveyance conduit 422 downstream of the flow control device 423 to detect the RAS flow to the AnMLFT 415 and communicate the readings to the control unit 418. Overflow from the AnMLFT 415 is then conveyed through conduit 425 to the anaerobic tank 405 of the A2O BNR process 402. An additional biosensor 426 may be incorporated into the screening and de-gritting process 401 such that it is suspended in a channel which conveys SD-WW to the influent conduit 404 for the BNR process 402. As such, the additional biosensor 426 may be utilized to monitor the SBC concentrations in the SD-WW and convey the readings to the control unit 418.

The side-stream embodiment of this invention allows for the continuous optimization of MLSS fermentation to yield the desired production of VFAs to support the BNR needs of a WWTP. The biosensor 417 suspended in the AnMLFT 415 detects real-time changes in the SBCUR. When the SBCUR readings from the biosensor 417 deviate beyond a threshold range set to optimize MLSS fermentation, specific changes are made to the operation of the AnMLFT 415 by the control unit 418. These operational changes can include modulating the influent flowrate (i.e. reactor HRT), reactor SRT, and influent RAS to SD-WW flow ratio. Operational changes to the AnMLFT 415 may also be implemented through the real-time SBC concentrations monitored in the influent SD-WW using the biosensor 426. These operational changes may be implemented to target a desired influent SBC loading to the AnMLFT 415 and/or to target a desired food-to-microorganism ratio (F:M) in the AnMLFT 415.

In either embodiment, the performance of the AnMLFT may be optimized through keeping the operating parameters constant while only allowing for one parameter to vary and observing the change in values measured using a biosensor. For instance, this can be done by keeping the reactor HRT (i.e. influent flowrate) and mixing intensity constant, while only allowing the percentage of RAS in the influent to vary. This will allow for the percentage of RAS in the influent flow which maximizes the production of VFAs through acetogenesis to be determined. With the optimum RAS percentage in the influent flow then held constant, the reactor HRT can then be varied to determine the HRT which maximizes acetogenesis and the production of VFAs. With the optimum reactor HRT then held constant, the mixing intensity can then be varied to determine the mixing intensity which maximizes acetogenesis. Furthermore, the SRT of the AnMLFT can also be varied through on/off cycling the mixing device to allow for the accumulation of solids in the reactor. The time interval between when the mixing device is on and when the mixing device is off determines the extent of solids accumulation in the reactor. By varying this time interval and recording the output from the biosensor, the optimum SRT of the fermentation reactor can be determined. Continuous optimization, whether manual or through an algorithm, allows for the continuous optimum production of VFAs through mixed liquor fermentation to supplement the BNR needs of a WWTP.

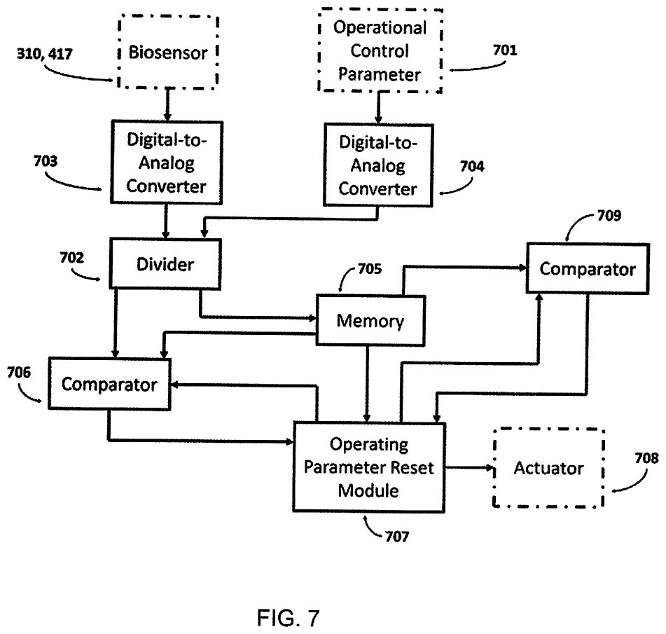

A flow chart which depicts how the control unit 311, 418 in either embodiment would perform the abovementioned performance optimization process is provided in FIG. 7. The control unit 311, 418 is operatively connected to the biosensor 310, 417 and the output from a single variable operational control parameter 701 for the AnMLFT 306, 415. The remaining operational control parameters for the AnMLFT 306, 415 are held constant such that the effect of the variable operational control parameter 701 on the SBCUR readings from the biosensor 310, 417 may be observed. The operational control parameters for the AnMLFT 306, 415 may be the mixing device(s) 309, 416 output, the rate of flow of RAS, and the rate of flow of SD-WW. The control unit 311, 418 is configured to determine the change in SBCUR readings imparted by an incremental adjustment made to the variable operational control parameter 701 as measured by the biosensor 310, 417. A divider 702 is included in the control unit 311, 418 which receives SBCUR readings from the biosensor 310, 417 through an analog-to-digital converter 703 and output data from the variable operational control parameter 701 through another analog-to-digital converter 704. The divider 702 may be implemented as a hard-wired logic circuit programmed to calculate the change in SBCUR per unit of adjustment made to the variable operational control parameter 701. The divider 702 may be connected to a memory 705 for storing successive values of rates of change in SBCUR per unit of adjustment made to the variable operational control parameter 701 at specified constant values assigned to the other operational control parameters of the AnMLFT 306, 415.

A comparator 706 may also be included in the control unit 311, 418 and be linked to the divider 702 and the memory 705 for comparing successive rates of SBCUR change per unit operational parameter adjustment quotients to determine whether the rates of SBCUR change are increasing or decreasing with respect to each unit of operational parameter adjustment. To change the variable operational parameter 701 to the end of maximizing the rate of SBCUR increase per unit of adjustment, the control unit 311, 418 is configured with an operating parameter reset module 707 to operate an actuator 708 which adjusts the variable operational control parameter 701. Operating parameter reset module 707 receives successive measures from the comparator 706 and memory 705 to determine the direction (increase or decrease) in which to adjust the variable operational control parameter 701. In this completely automated embodiment, the control unit 311, 418 automatically adjusts the actuator 708 in response to the rate of change in SBCUR per unit of adjustment made to the operational control parameter 701 as calculated by the divider 702. The comparator 706 automatically compares successive SBCUR rate change calculations and the operating parameter reset module 707 automatically adjusts the actuator 708 in accordance with the rates of SBCUR change per unit adjustment to the variable operational control parameter 701 as determined by the operation of the comparator 706.

In some cases, the variable operational control parameter 701 may be restrained by minimum or maximum values with respect to its operation. The control unit 311, 418 is equipped with an additional comparator 709 connected to the memory 705 and the parameter reset module 707 for ensuring that the pre-selected maximum or minimum values for the variable operational control parameter 701 are not exceeded. The comparator 709 compares a prospective operational adjustment from operating parameter reset module 707 with reference to values stored in memory 705 and informs the operating parameter reset module 707. If a minimum or maximum operational value would be breached by an impending adjustment, operating parameter reset module 707 determines additional prospective adjustments to avoid exceeding a minimum or maximum value. The various functional building blocks of the control unit 311, 418, particularly comparators 706, 709, divider 702, and parameter reset module 707 may take the form of hard-wired logic circuits or, alternatively, generic digital processing circuits of a microprocessor modified by programming to carry out the intended functions. Through performing the SBCUR optimization process described above and illustrated in FIG. 7 for each operational control parameter of the AnMLFT 306, 415, the memory 705 of the control unit 311, 418 would have sufficient data to draw from in automatically optimizing the MLSS fermentation system in real-time based on SBCUR readings from a biosensor 310, 417 and the respective output from each operational control parameter.

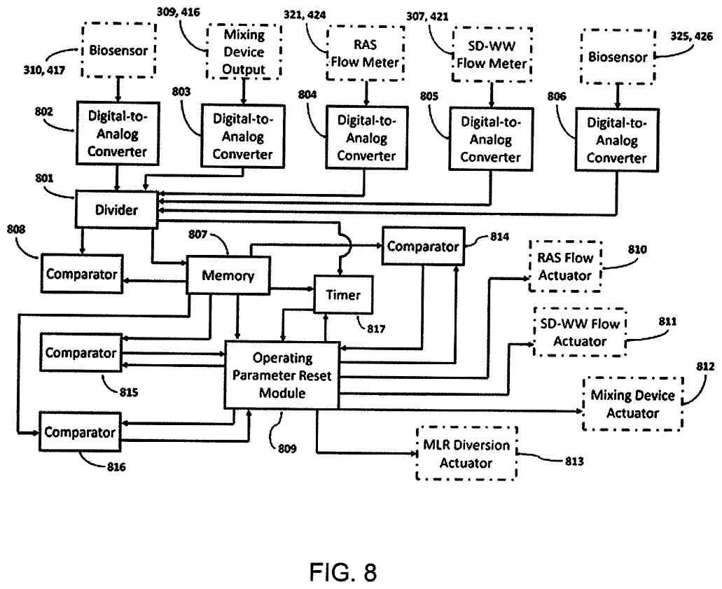

For control of the entire MLSS fermentation system, depicted in FIG. 5 and FIG. 6, the control unit 311, 418 may be expanded from the unit described above and depicted in FIG. 7 to include inputs from all the AnMLFT 306, 415 operational control parameters, inputs from the influent SD-WW biosensors 325, 426, and provide outputs directing the adjustment of each individual operation control parameter. An example flow chart depicting the control unit utilized for the control of the entire MLSS fermentation system is depicted in FIG. 8. The control unit 311, 418 is operatively connected to a biosensor 310, 417 suspended in the AnMLFT 306, 415 basin, the output from the mixing device(s) 309, 416, the RAS flow meter 321, 424, the SD-WW flow meter 307, 421, and the biosensor 325, 426 suspended in the SD- WW conveyance channel. The control unit 311, 418 is configured to determine whether the SBCUR readings from the biosensor 310, 417 are within a threshold range set to optimize MLSS fermentation. A divider 801 is included in the control unit 311, 418 which receives SBCUR readings from the biosensor 310, 417 through an analog-to-digital converter 802, output from the mixing device 309, 416 through another analog-to-digital converter 803, RAS flow meter readings 321, 424 through another analog-to-digital converter 804, SD-WW flow meter readings 307, 421 through another analog-to-digital converter 805, and SBCUR readings from the SD-WW biosensor 325, 426 through yet another analog-to-digital converter 806. The divider 801 may be implemented as a hard-wired logic circuit programmed to determine whether the SBCUR readings from the biosensor 310, 417 are within a set threshold range. The divider 801 may also be connected to a memory 807 for storing successive SBCUR readings with respect to input values from each of the operational control parameters of the AnMLFT 306, 415. A comparator 808 is included in the control unit 311, 418 and may be linked to the divider 801 and memory 807 for comparing successive SBCUR readings to determine whether the readings are increasing or decreasing with respect to input from the operational control parameters of the AnMLFT 306, 415.

To regulate each respective operational control parameter of the AnMLFT 306, 415 to the end of containing the SBCUR readings within a set threshold range, the control unit 311, 418 includes an operating parameter reset module 809 to operate various actuators 810, 811, 812 which adjust the output of each respective operational control parameter. Operating parameter reset module 809 receives successive data from comparator 808 and memory 807 and determines the adjustments needing to be made to each respective actuator 810, 811, 812 to elicit a change in SBCUR readings from the biosensor 310, 417 estimated to be sufficient to return them to within a set threshold range. In a completely automated embodiment, control unit 311, 418 automatically adjusts actuators 810, 811, 812 in response to real-time SBCUR readings from the biosensor 310, 417 and the input from each operational control parameter as determined by the divider 801.

A control process for MLSS fermentation optimization may include the setting of minimum and maximum RAS flowrates for restricting the MLSS loading to desired limits. In this case, control unit 311, 418 provides an additional comparator 814 connected to memory 807 and the operating parameter reset module 809 for ensuring that the pre-selected maximum or minimum RAS flow values are not exceeded. Comparator 814 compares a prospective adjustment to the RAS flow control device actuator 810 from the operating parameter reset module 809 with reference to values stored in memory 807 and informs the operating parameter reset module 809. If a RAS flowrate limit is met or exceeded by an impending adjustment, operating parameter reset module 809 determines additional prospective adjustments to actuators 810, 811, 812 which avoid exceeding pre-selected MLSS loading limits while still allowing for the SBCUR readings from the biosensor 310, 417 to be adjusted to within a set threshold range.

Similarly, a control process for MLSS fermentation optimization may include the setting of minimum and maximum SD-WW flowrates for restricting the SBC loading to desired limits. In this case, the control unit 311, 418 provides an additional comparator 815 connected to memory 807 and the operating parameter reset module 809 for ensuring that the pre-selected maximum or minimum SD-WW flowrates are not exceeded. Comparator 815 compares a prospective adjustment to the SD-WW flow control device actuator 811 from the operating parameter reset module 809 with reference to the values stored in memory 807 and informs the operating parameter reset module 809. If an SD-WW flowrate limit is met or exceeded by an impending adjustment, operating parameter reset module 809 determines additional prospective adjustments to actuators 810, 811, 812 which avoid exceeding pre-selected SBC loading limits while still allowing for the SBCUR readings from the biosensor 310, 417 to be adjusted back to within a set threshold range.

A control process for MLSS fermentation optimization may also include the setting of minimum and maximum outputs provided by the mixing device(s) for restricting the mixing output provided in the AnMLFT to desired limits. In this case, the control unit 311, 418 provides an additional comparator 816 connected to memory 807 and the operating parameter reset module 809 for ensuring that the pre-selected maximum or minimum mixing outputs are not exceeded. Comparator 816 compares a prospective adjustment to the mixing device actuator 812 from the operating parameter reset module 809 with reference to the values stored in memory 807 and informs the operating parameter reset module 809. If a mixing output limit is met or exceeded by an impending adjustment, operating parameter reset module 809 determines additional prospective adjustments to actuators 810, 811, 812 which avoid exceeding pre-selected mixing limits while still allowing for the SBCUR readings from the biosensor 310, 417 to be adjusted back to within a set threshold range.

For in-line embodiments of this invention, an additional actuator 813 which controls the MLR flow diversion device 316, and a timer 817 is incorporated into the operational flow of the control unit 311. The MLR diversion actuator 813 is operatively connected to the operating parameter reset module 809 such that the MLR flow diversion device 316 may be automatically adjusted by the control unit 311. The timer 817 is operatively linked to the divider 801, memory 807 and the operating parameter reset module 809. Under normal flow conditions, the control unit 311 sits idle and the output for the operational control parameters for the AnMLFT 306 are set to constant values established for A2O operation. Once the divider 801 receives inputs from SD-WW flowmeter 307 and/or the SD-WW biosensor 325 that are below a low-flow threshold, the divider 801 sends a signal which initiates the timer 817. The initiated timer 817 then directs the operating parameter reset module 809 to adjust the actuators of the operational control parameters 810, 811, 812, 813 to the outputs which were in place when the previous MLSS fermentation cycle terminated, as stored in the memory 807. The control unit 311 will then proceed to automatically adjust the operational control parameter actuators 810, 811, 812, 813 in response to the SBCUR readings from the biosensor 310. The control unit 311 will continue to remain in operation until the timer 817 reaches the average low-flow time, as stored in the memory 807. When the average low flow time expires, the operating parameter reset module 809 will adjust the operational control parameter actuators 810, 811, 812, 813 back to the constant output values established for normal A2O operation and the control unit 311 will then revert to idle mode. Alternatively, fermentation mode may also be terminated by the SD- WW flowmeter 307 and/or the SD-WW biosensor 325 readings rising above a low-flow threshold before the average low flow time expires on the timer 817.

For side-stream embodiments, the timer 817 incorporated into the control unit 418 may be utilized to specify the time interval between when adjustments may be made to the variable operational control parameters of the AnMLFT 415. For instance, when operating parameter reset module 809 makes an adjustment to the operational control parameter actuators 810, 811, 812 in response to real-time SBCUR readings from the biosensor 417, the timer 817 is initiated. The control unit 418 will then sit idle until a pre-determined period of time has elapsed, wherein the timer 817 will then reinitiate the operating parameter reset module 809 to continue to make adjustments if the SBCUR readings from the biosensor 417 are still outside of a set threshold range.

As the MLR flow diversion device 316 is not included in the side-stream embodiment of this invention, subsequently the MLR flow diversion actuator 813 would not be included in the operation of the control unit 418 for side-stream embodiments.

### Hypothetical Example 1: In-Line MLSS Fermentation

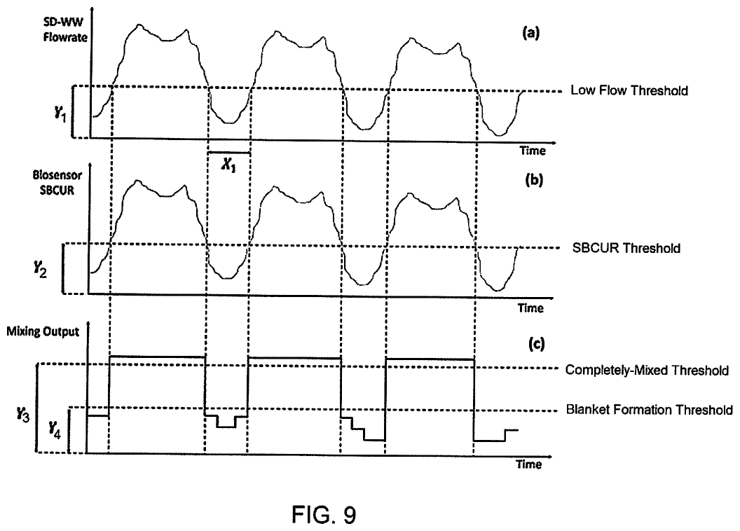

A WWTP has an in-line embodiment of the disclosed invention, similar to the process depicted in FIG. 5. Since startup, the in-line embodiment was operating under normal A2O operation for multiple months where cyclic fermentation cycles were not implemented. Over this period, the control unit 311 has been receiving and storing successive SD-WW flowrate readings from the SD-WW flow meter 307 along with the corresponding SBCUR/SBC readings from the SD-WW biosensor 325. In the SD-WW there is no carbon uptake rate, only SBC, but a biosensor pre-loaded with bacteria can be used, so that SBCUR of such a biosensor reflects SBC in the SD-WW. The data collected over the multiple months of A2O operation has enabled the diurnal and/or seasonal variation in SD-WW flow to the AnMLFT (306) to be known and/or estimated. Additionally, the corresponding variation in SBC readings due to the diurnal and/or seasonal variation in SD-WW flow are also able to be determined and/or estimated from the multiple months of A2O data. As depicted in panels “a” and “b” in FIG. 9, the operational data collected by control unit 311 has identified a correlation between the diurnal variations in the SD-WW flow to the AnMLFT 306 and the diurnal variations in SBCUR readings from the SD-WW biosensor 325. Low flow conditions, specified by a minimum SD-WW flowrate threshold (Y₁), is utilized to determine the accompanying SBCUR reading threshold (Y₂) that is representative of low flow conditions. Low flow conditions may be specified by an SD-WW flowrate that equates to a nitrogen loading to the BNR process 302 which enables the volume of the pre-anoxic basin 312 to be reduced by a specific volume. In this example, the specified volume reduction equates to the volume of one of the three tanks composing the pre-anoxic basin 312. The average time in which the SD-WW flowrates are below the low flow threshold (Y₁) can be estimated from the A2O operational data collected by the control unit 311. This average low flow time increment (X₁) may then be utilized to specify the length of the MLSS fermentation cycles through the timer 817 incorporated in the control unit 311.

With sufficient data collected under normal A2O operation by the control unit

311, the parameters for a control process for an in-line embodiment of cyclic MLSS fermentation can be determined and optimized. The initiation of the system to proceed from A2O operation into fermentation mode may be induced through SBC readings from the SD-WW biosensor 325 falling below a low flow SBCUR reading threshold (Y₂) and/or SD-WW flowrate readings falling below a low flow threshold (Y₁). When one or more low flow thresholds have been exceeded, fermentation mode is initiated, and the timer 817 is started. In this example, the RAS flowrate to the AnMLFT 306 is held constant from normal A2O operation and the SD-WW flowrate is not controlled. Thus, the mixing output provided in the AnMLFT 306 by the mixing device(s) 309 is the sole operational control parameter which may be varied under fermentation mode. With the initiation of the system into fermentation mode, the MLR discharge is diverted with the flow diversion device 316 from the first tank of the pre-anoxic basin 312 to the second tank, effectively increasing the anaerobic volume while maintaining a pre-anoxic volume sufficient to sustain the nitrogen removal required of the BNR process 302. Furthermore, the output from the mixing device(s) 309 is reduced from above a mixing output threshold (Y₃) which completely-mixes the contents of the AnMLFT 306 and the first tank of the pre-anoxic basin 312 to below the mixing output threshold (Y₄) which results in the formation of a sludge blanket, as illustrated in panel “c” in FIG. 9. Under fermentation mode, the output of the mixing device(s) 309 is adjusted by the control unit 311 in response to the rate of change in SBCUR readings from the biosensor 310, according to a similar control methodology as the one depicted in FIG. 7. In this example, the maximum output from the mixing device 309 is restricted to the output which results in the formation of a sludge blanket (Y₄) such that the SRT of the AnMLFT 306 can exceed its HRT. The cessation of fermentation mode is brought about by the SBC readings from the SD-WW biosensor 325 rising above the low flow SBC threshold (Y₂), and/or by the MLSS fermentation time exceeding the average low flow time interval (X₁) on the timer 817 of the controller, and/or by the SD-WW flowrate rising above the low flow threshold (Y₁). With one or more of the low flow thresholds being exceeded, fermentation mode is ceased, and the system is directed back into normal A2O operation wherein the output from the mixing device(s) 309 is increased to above the completely mixed threshold (Y₃) and the MLR discharge is directed with the flow diversion device 316 back to the first (upstream) tank of the pre-anoxic basin 312.

### Hypothetical Example 2: Side-Stream MLSS Fermentation

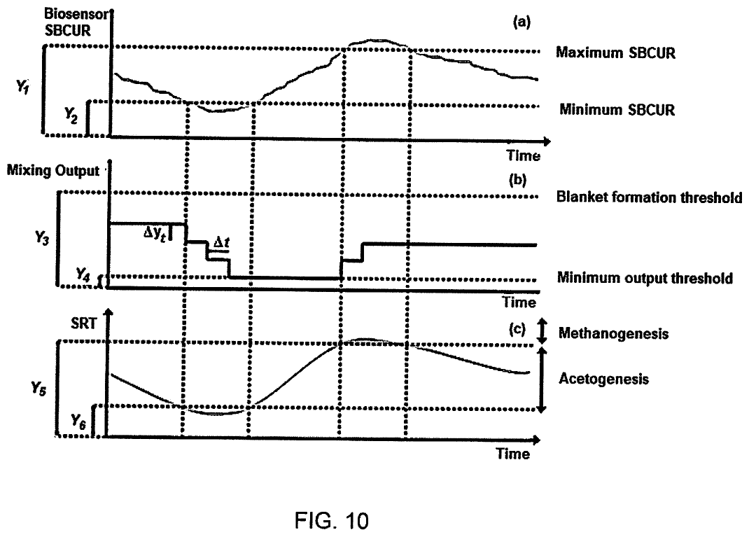

A WWTP has a side-stream embodiment of the disclosed invention, similar to the process depicted in FIG. 6. The operation of the AnMLFT 415 is restricted to a constant influent flowrate set to meet a desired VFA production/loading to supplement the needs of the main-stream BNR process 402. The HRT of the AnMLFT 415 is held constant at 2-days, which is lower than the SRT necessary for optimum MLSS fermentation, however, enables a smaller tank volume and subsequently reduced capital costs than if the HRT of the AnMLFT 415 was set to the SRT necessary for optimum MLSS fermentation. Further, the influent SD-WW and RAS flowrates to the AnMLFT 415 are held constant to provide a constant reactor HRT of 2-days and constant influent MLSS loading. Consequently, the output from the mixing device(s) 416 is the only variable operational control parameter for the AnMLFT 415. As the HRT of the AnMLFT 415 is lower than the SRT necessary for optimum acetogenesis, the maximum output provided by the mixing device 416 is constrained to the output in which a sludge blanket forms (Y₃ in Panel “b” in FIG. 10) such that the SRT of the AnMLFT 415 can exceed its HRT. Through operating the AnMLFT 415 with varying outputs from the mixing device 416 below the sludge blanket output threshold (Y₃), and allowing for the system to come to steady state after each incremental change, the effects on both the SBCUR readings from the biosensor 417 and the SRT of the AnMLFT 415 can be determined by the control unit 418 for each incremental change made to the output from the mixing device 416. With sufficient operational data collected and stored in the memory 807 (FIG. 8) of the control unit 418 over a mixing device 416 output ranging from no mixing to the sludge blanket output threshold (Y₃), the effect that the output from the mixing device 416 has on both the SRT of the AnMLFT 415 and the SBCUR readings from the biosensor 417 can be determined. Thus, operational thresholds can be implemented for the biosensor SBCUR readings which correlate with a mixing output range that enables the SRT of the AnMLFT 415 to fall within an optimum range for MLSS fermentation (3-5 days).

FIG. 10 illustrates the control system developed for the AnMLFT 415 based on the operational data collected from varying the output from the mixing device 416 from the blanket formation output threshold (Y₃) all the way to no mixing output. The collected data revealed correlations between the output provided from the mixing device (Panel “b” in FIG. 10), SBCUR readings from the biosensor (Panel “a” in FIG. 10), and the SRT of the AnMLFT (Panel “c” in FIG. 10). Operating thresholds have been applied to the SBCUR readings from the biosensor 417 which correlate with the minimum and maximum SRT of the AnMLFT which results in optimized MLSS fermentation. The maximum SBCUR threshold (Y₁) is implemented to prevent the SRT of the AnMLFT 415 from exceeding the maximum operating SRT (Y₅) for optimum MLSS fermentation. Similarly, the minimum SBCUR threshold (Y₂) is implemented to prevent the SRT of the AnMLFT 415 from falling below the minimum operating SRT (Y₆) for optimum MLSS fermentation. Operating thresholds are also applied to the output from the mixing device 416 to be confined to the maximum output in which a sludge blanket is formed (Y₃) and the minimum mixing output which prevents the permanent deposition of solids (Y₄) in the tank.

For control of the AnMLFT 415, the SBCUR readings from the biosensor 417 are utilized to indicate when operational adjustments are needed. When an SBCUR threshold is exceeded, the mixing device output is adjusted by a predetermined magnitude (Δyₜ) estimated by the control unit 418 to bring the SBCUR readings back to within a threshold range. The control unit may make additional adjustments of a predetermined magnitude (Δyₜ) to the output of the mixing device 416 if after a predetermined interval of time (Δt) has elapsed and the SBCUR readings have not changed by an anticipated magnitude. For side-stream embodiments, the timer 817 in the control unit 418 may be utilized to keep track of the time that has elapsed since adjustments have been made to output from the mixing device 416 to inform the operating parameter reset module 809 when a predetermined interval of time (Δt) has been reached. In the case where the maximum SBCUR threshold (Y₁) is exceeded, this would indicate that too much SBC is being generated in the AnMLFT 415 for the needs of the mainstream BNR process (402) and consequently that the SRT is too long for optimized MLSS fermentation. In this scenario, the SRT of the AnMLFT 415 would be incrementally reduced by the operation of the control unit 418 directing the mixing device 416 to incrementally increase its output such that more solids are wasted in the effluent of the AnMLFT 415. For the case where the SBCUR readings from the biosensor 417 fall below the minimum SBCUR threshold (Y₂), this would indicate that insufficient SBC is being produced from MLSS fermentation to support the needs of the mainstream BNR process 402 due to the SRT of the AnMLFT 415 being too short. In this scenario, the SRT of the AnMLFT 415 would be incrementally increased by the operation of the control unit 418 directing the mixing device 416 to incrementally reduce its output such that more solids are retained within the AnMLFT 415. When the SBCUR readings from the biosensor 417 are within the maximum and minimum SBCUR thresholds (Y₁ and Y₂, respectively), the output from the mixing device 416 is held constant until future threshold deviations are detected.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim

1. A system for the control of mixed liquor fermentation in a continuous-flow biological wastewater treatment process which removes organic matter, nitrogen and/or phosphorus from wastewater, the system comprising:
a biological nutrient removal (BNR) process including a succession of anaerobic, anoxic, and aerated process zones, wherein means are provided for adjusting in real time the anaerobic solids retention time (SRT) of said BNR process to initiate, optimize, or cease mixed liquor fermentation in said anaerobic process zone,
a biosensor equipped in the anaerobic process zone of said BNR process, the biosensor having means of outputting a signal correlating to the soluble biodegradable carbon uptake rate (SBCUR) in said anaerobic process zone, and
a controller operably connected to said biosensor with means to receive and analyze the SBCUR signals from the biosensor, wherein the controller has means for initiating, optimizing, and ceasing mixed liquor fermentation in said anaerobic process zone by adjusting the anaerobic SRT of said BNR process whereby sufficient volatile fatty acids (VFAs) can be generated endogenously to supplement the VFA needs of said BNR process.

2. The system of claim 1, further comprising:
a preliminary treatment zone upstream of said BNR process, the preliminary treatment zone having means for at least screening and/or de-gritting the raw wastewater to produce a preliminarily treated wastewater,
a first conduit equipped with a remotely controllable valve and a flow meter for conveying said preliminarily treated wastewater to the anaerobic process zone of said BNR process, wherein said remotely controllable valve and flow meter being operably connected to said controller, the controller having means to control the flowrate of said preliminarily treated wastewater at a desired set point at least partially in response to the signals from the biosensor, and
a bypass conduit branching off the first conduit upstream of the remotely controllable valve and flow meter, said bypass conduit having means to divert excess preliminarily treated wastewater to said anoxic process zone such that the hydraulic retention time (HRT) of the anaerobic process zone may be adjusted.

3. The system of claim 1, further comprising:
a gravity settling clarifier downstream of said BNR process, the gravity settling clarifier having means to produce a return activated sludge (RAS) stream and a treated wastewater effluent,
a RAS pump to convey said RAS stream to said anerobic process zone of the BNR process,
a RAS conduit equipped with a remotely controllable valve and a flow meter for conveying said RAS stream to said anaerobic process zone of the BNR process, said remotely controllable valve and flow meter being operably connected to the controller, the controller having means to control the flowrate of said RAS stream at a desired set point at least partially in response to the signals from said biosensor, and
a bypass conduit branching off said RAS conduit upstream of said remotely controllable valve and flow meter, said bypass conduit extending to the anoxic process zone, said bypass conduit providing means to divert excess RAS to the anoxic process zone such that solids loading rate to the anaerobic process zone may be adjusted without adjusting the operation of the gravity settling clarifier.

4. The system of claim 1, further comprising a speed-controllable mixer equipped in the anaerobic process zone and operably connected to the controller, whereby the controller has means to control the mixer speed and/or time interval which the mixer is operated is at least in partial response to signals received from the biosensor.

5. The system of claim 1, wherein:
said anoxic process zone of said BNR process is compartmentalized into multiple tanks operably connected in series,
a first tank of said anoxic process zone being operably connected to said anaerobic process zone to receive effluent from said anaerobic process zone,
said aerated process zone of said BNR process being operably connected to a final tank of said anoxic process zone to receive effluent from the anoxic process zone,
an internal recycle pump equipped near a downstream end of said aerated process zone, the internal recycle pump providing means to convey recycle mixed liquor from the aerated process zone to a remotely controllable flow diversion device,
said internal recycle pump being operably connected to said controller, said remotely controllable flow diversion device being operably connected by conduits to each tank of the anoxic process zone, and said remotely controllable flow diversion device being operably connected to the controller,
said controller having means for controlling the remotely controllable flow diversion device to direct the recycle mixed liquor from the aerated process zone to a specific tank of the anoxic process zone at least partially in response to the SBCUR signals from the biosensor,
the tanks of the anoxic process zone being convertible from anoxic to anaerobic, the controller having means to adjust the anaerobic volume of said BNR process by converting specific tanks of the anoxic process zone to anaerobic tanks and vice versa through controlling said remotely controllable flow diversion device at least partially in response to the SBCUR signals from the biosensor.

6. The system of claim 1, further comprising an additional biosensor positioned upstream of said BNR process and operably connected to said controller, the additional biosensor having means for outputting a signal correlating to the soluble biodegradable carbon (SBC) concentration in said preliminary treated wastewater, the controller having means for receiving and analyzing the SBC signals from the additional biosensor, whereby the controller provides means for initiating or ceasing mixed liquor fermentation at least partially in response to the SBC signals from said additional biosensor being outside a pre-determined range.

7. A system for the control of mixed liquor fermentation in a biological wastewater treatment process, the system comprising:
a preliminary treatment zone having means for receiving raw wastewater and producing an effluent of preliminarily treated wastewater for a biological nutrient removal (BNR) process, said preliminary treatment zone providing means for screening and/or de-gritting the raw wastewater,
a gravity settling clarifier downstream of said BNR process providing means to separate activated sludge solids from treated wastewater and produce streams of return activated sludge (RAS) and treated wastewater,
an anaerobic mixed liquor fermentation tank (AnMLFT) as a zone of said BNR process, with means to receive inputs of said preliminarily treated wastewater and said RAS, with additional means to deliver effluent downstream in the BNR process,
a first conduit equipped with a remotely controllable valve and a flow meter for conveying said preliminarily treated wastewater to said AnMLFT, whereby said remotely controllable valve and flow meter provide means for controlling the flowrate of said preliminarily treated wastewater at a desired set point,
a second conduit equipped with a remotely controllable valve and flow meter for conveying said RAS to the AnMLFT, whereby said remotely controllable valve and flow meter provide means for controlling the flowrate of RAS at a desired set point,
a remotely controllable variable speed mixing device equipped in said AnMLFT, providing means for producing alternatively stratified conditions or completely mixed conditions in the AnMLFT,
a biosensor equipped in said AnMLFT, having means to output a signal correlating to soluble biodegradable carbon uptake rate (SBCUR) in said AnMLFT, and
a controller operably connected to said biosensor, to said remotely controllable variable speed mixing device, to said flow meters, and to said remotely controllable valves, for providing means to control the operation of said AnMFLT at least partially in response to the SBCUR signals from said biosensor to provide a consistent output of volatile fatty acids (VFAs) from said AnMLFT to supplement the VFA needs of said BNR process.

8. A method for operating a continuous flow wastewater treatment system to accomplish in-line mixed liquor fermentation, said system comprising a BNR process including a succession of anaerobic, anoxic, and aerated process zones, along with a downstream gravity settling clarifier, said method comprising:
operating remotely controllable variable speed mixing devices in said anaerobic and anoxic process zones of said BNR process to control an amount of mixing energy provided in said anaerobic and anoxic process zones,
partitioning said anoxic process zone with baffles such that the anoxic process zone becomes multi-staged and behaves as multiple tanks operably connected in series,
pumping mixed liquor from a downstream end of the aerated process zone of said BNR process to a remotely controllable flow diversion device through a conduit using a mixed liquor recycle (MLR) pump, whereby said remotely controllable flow diversion device is operably connected to each stage or tank of said anoxic process zone through respective conduits enabling the MLR to be selectively conveyed to any of the stages or tanks,
a control system utilizing said mixing devices, said MLR pump, said flow diversion device and said conduits to effect a transition in the BNR process operation from a normal anaerobic/anoxic/oxic (A2O) mode of operation to a mixed liquor fermentation mode of operation, whereby both the anaerobic HRT and anaerobic SRT of said BNR process are increased to support mixed liquor fermentation, wherein the anaerobic HRT is increased through effecting an increase in the anaerobic volume of said BNR process by converting a portion of the anoxic process zone to anaerobic by directing said remotely controllable flow diversion device to convey said MLR to a further downstream stage of the anoxic process zone, wherein the anaerobic SRT is increased through directing the remotely controllable variable speed mixing devices in the developed anaerobic volumes of said BNR process to reduce mixing energy output to enable solids to accumulate such that a fermenting sludge blanket may be developed in the anaerobic volume.

9. The method defined in claim 8, further comprising operating a biosensor in said anaerobic process zone of said BNR process, correlating the output signal from said biosensor to a soluble biodegradable carbon utilization rate (SBCUR) in the anaerobic process zone, and controlling the mixing energy output of said remotely controllable variable speed mixing devices in the anaerobic and anoxic process zones at least partially in accordance with the output from said biosensor.

10. The method defined in claim 8, further comprising operating a flow meter on a conduit conveying influent wastewater to said BNR process, whereby said mixed liquor
fermentation mode of operation is at least partially initiated by the flow meter detecting flowrate readings decreasing below a predetermined low flow threshold, and whereby the cessation of said mixed liquor fermentation mode of operation is at least partially controlled in accordance with detection that flowrate has risen back above said predetermined low flow threshold.

11. The method defined in claim 8, further comprising operating an influent biosensor in a conduit conveying influent wastewater to said BNR process, correlating output from said influent biosensor to the soluble biodegradable carbon (SBC) in said influent wastewater, and controlling initiation and cessation of said mixed liquor fermentation mode of operation at least partially in accordance with the output from said influent biosensor exceeding a predetermined low SBC threshold.

12. The method defined in claim 8, further comprising operating a timer, whereby said mixing devices, said MLR pump, and said flow diversion device are directed to transition from the normal A²O mode of operation to the mixed liquor fermentation mode of operation at least in part by the commencement of said timer, and whereby said mixing devices, said MLR pump, and said flow diversion device are directed to transition from the mixed liquor fermentation mode of operation to the normal A²O mode of operation at least in part by the termination of said timer.

13. A method for operating a tank assembly within a wastewater treatment system for mixed liquor fermentation to produce volatile fatty acids (VFAs) for use in said system to enhance the BNR efficiency, said system including a wastewater collection influent region, a BNR process, a downstream gravity settling clarifier, and a mixed liquor fermentation tank assembly, the method comprising:
flowing a portion of influent wastewater containing biodegradable carbon components to said mixed liquor fermentation tank assembly at a predetermined rate,
flowing a portion of underflow of the downstream gravity settling clarifier as return activated sludge (RAS) containing concentrated microorganisms to said mixed liquor fermentation tank at a predetermined rate, wherein mixing with said influent wastewater forms a mixed liquor,
operating a remotely controllable variable speed mixer in said mixed liquor fermentation tank assembly to enable a fermenting sludge blanket to develop, and
using a controller, optimizing mixed liquor fermentation by adjusting the HRT and/or SRT of said mixed liquor fermentation tank assembly, wherein the HRT is adjusted by adjusting flowrate of said influent wastewater and/or RAS to said mixed liquor fermentation tank assembly, and wherein the SRT is adjusted by adjusting energy output from said remotely controllable variable speed mixer such that the density of said fermenting sludge blanket is also adjusted.

14. The method defined in claim 13, further comprising operating a biosensor in said mixed liquor fermentation tank assembly, correlating an output signal from the biosensor to the soluble biodegradable carbon utilization rate (SBCUR) in the mixed liquor fermentation tank assembly, and controlling the mixing energy output of said remotely controllable variable speed mixing device in the mixed liquor fermentation tank assembly at least partially in accordance with the output from the biosensor.

15. The method defined in claim 13, further comprising operating a flow meter on a conduit conveying influent wastewater to the mixed liquor fermentation tank assembly, operating a remotely controllable valve on said conduit conveying influent wastewater, and utilizing a control system to adjust said remotely controllable valve such that the influent wastewater flowrate to the mixed liquor fermentation tank assembly may be controlled at a desired set point.

16. The method defined in claim 13, further comprising operating a flow meter on a conduit conveying RAS to the mixed liquor fermentation tank assembly, operating a remotely controllable valve on said conduit conveying RAS, and utilizing a control system to adjust said remotely controllable valve such that flowrate of RAS to the mixed liquor fermentation tank assembly is controlled at a desired set point.

17. The method defined in claim 15, further comprising operating an influent biosensor in said conduit conveying influent wastewater to the mixed liquor fermentation tank assembly, correlating output from said influent biosensor to the soluble biodegradable carbon (SBC) in the influent wastewater, and utilizing a control system to adjust flowrate of the influent wastewater to the mixed liquor fermentation tank assembly at least partially in accordance with the output from said influent biosensor.

18. The method defined in claim 15, further comprising operating a biosensor in said mixed liquor fermentation tank assembly, correlating an output signal from said biosensor to the soluble biodegradable carbon uptake rate (SBCUR) in said mixed liquor fermentation tank assembly, and controlling flowrate of influent wastewater to the mixed liquor fermentation tank assembly at least partially in accordance with the output from said biosensor.

19. The method defined in claim 16, further comprising operating a biosensor in said mixed liquor fermentation tank assembly, correlating an output signal from said biosensor to the SBCUR in said mixed liquor fermentation tank assembly, and controlling the flowrate of said RAS to the mixed liquor fermentation tank assembly at least partially in accordance with the output from said biosensor.
